(19) United States
(12) Patent Application Publication
(10) Pub. No.: US 2015/0300617 A1
(43) Pub. Date: Oct. 22, 2015

(54) LINEAR PENDANT LUMINAIRE

(71) Applicant: NEXT LIGHTING, CORP., San Francisco, CA (US)

(72) Inventors: Thomas M. Katona, San Luis Obispo, CA (US); Steve Paolini, Saratoga, CA (US); Randall Sosnick, Mill Valley, CA (US)

(21) Appl. No.: 14/621,210

(22) Filed: Feb. 12, 2015

Related U.S. Application Data
(60) Provisional application No. 61/940,173, filed on Feb. 14, 2014.

(51) Int. Cl. F21V 23/04; F21V 23/00; F21S 8/06

(52) U.S. Cl. CPC F21V 23/0442; F21S 8/06; F21V 23/005

(57) ABSTRACT

A luminaire may be provided having multiple elongated bodies. The light emitted by the elongated bodies may be controlled independently of one another. The position of the bodies relative to one another or a reference point r be altered independently of one another. The luminaire may be a pendant luminaire hat may hang from a surface.

### CROSS-REFERENCE

This application claims the benefit of U.S. Provisional Application No. 61/940,173, filed Feb. 14, 2014, which application is incorporated herein by reference.

### BACKGROUND OF THE INVENTION

Large numbers of linear lamps and luminaires are commonly used in commercial buildings and other spaces to provide ambient light in the form of fluorescent troffers. In addition, linear solutions are found in coves and wall washing applications where appearance is important. As the lighting power densities (watts per square foot) continue to drop to reduce energy consumption, there is pressure on the light source to be inherently more efficient and/or be positioned closer to the work surface. Pendant luminaires have been provided to be positioned closer to the work surface.

One consequence of moving the light closer to the work surface is the ceiling gets darker. A dark ceiling can have the generally undesirable impression of being in a cave.

### SUMMARY OF THE INVENTION

A need exists for improved luminaires that effectively provide light to a work surface while also providing sufficient ambient light to brighten the overall area.

Pendant luminaires can come in many forms but often are suspended from the ceiling with a single point of attachment that serves as both the mechanical support and electrical conduit for the luminaire. Multiple attachment points are also common, particularly with extended sources such as linear and area lights.

Pendant luminaires are often used for aesthetic reasons but can become a part of an energy savings plan that brings the light source closer to the work surface, or in general closer to any plane to be illuminated. This can be a powerful approach because the increase in illuminance on the work surface may be approximately equal to the square of the change in height. In other words, if the distance between the light source and the work surface is cut in half, the illuminance can increase by a factor of four. Or, for the same illuminance, only one quarter of the power would be needed. In practice, smaller changes in distance are the norm, but the impact follows the same relationship.

Moving the light closer to the work surface may cause the ceiling to get darker. To counter this effect, some pendants may send a portion of the light up towards the ceiling to brighten it and at the same time reflect some light back into the room. This may increase light uniformity in the space. Just as moving the light source closer to the work surface increases illuminance and/or efficiency, the relationship of the up light to the ceiling can have a similar effect.

Linear pendants can be used in places where fluorescent troffers are commonly used, in coves, as wall washers, as linear track lights, as architectural statements, or any place where a high aspect ratio of length to width of the light source is appropriate. With the addition of solid-state light sources, other forms and functions are possible. For example, the spectral output can be tuned to accommodate the time of day or season of year as desired. The up-and-down light portions of the luminaire can be dynamically tuned separately for aesthetics, productivity, and/or energy savings. The up-and-down lights can also be physically tuned in relation to the work surface, the ceiling, and each other for maximum effect. This spacing adjustment could be set at the factory, at the time of installation, or can be changeable after installation by the user either manually or with motors and controls.

Another application for linear light sources is backlighting corporate logos and trademarks. Light boxes can be filled with linear fluorescent lamps and a filter material, sometimes including working and designs, on the front side to deliver a lighted message. Solid state alternatives may be used, which may allow a more compact, lower maintenance, alternative for this application. Thus, solid state light sources, such as those described herein may be used in light box applications.

To continue with the theme of lighting multiple surfaces, another lighting element or elements could be positioned in-between the up-and-down lights previously described. For example, an edge-lit light guide could be designed in such a way to direct light to the right and/or to the left toward vertical surfaces such as walls. Similarly the up-light and down-light portions could be made of multiple elements to provide more light or position the light distribution where it is most needed. Vertical illuminance is often overlooked, except in the case of windows, and even then at night windows are no longer an active light source. The side-to-side light could be made from various optical elements as described elsewhere and include various light sources, including solid state light sources. The up, down, left, and/or right lighting elements can be of any form, any function, or any type mentioned here, and controllable together or separately electrically, optically, and mechanically.

An important characteristic of any light source is glare, and to some extent the pixilation of the light if many sources are used. Several methods of mitigating glare may be employed. These can include one or more of the following: (a) masks that block light from exiting the luminaire over the most offensive angles; (b) reflectors, including light guides, that redirect the light away from a glare location, and (c) diffusers, that can spread light over a larger area and reduce the luminance of the source. Diffractors, including lenses and free form optics, and refractors can also be used to redirect or diffuse light where it should go and away from where it should not. An implementation of glare reduction and de-pixilation may be to point the light source away from the primary illumination plane and toward an efficient diffuse reflector. The diffuse reflector can then efficiently redirect light onto the plane to be illuminated. Beyond glare, shaping and controlling the light distribution may be a useful characteristic of any luminaire. Standard or specialized light shaping elements can be used here, including in asymmetric applications such as a wall wash.

Since solid-state light sources are often low voltage and low power, it is possible to use a mechanical suspension mechanism—cable or tube for example—as the electrical connection as well. This is generally not possible with traditional light sources such as fluorescent tubes.

The length of the pendant luminaires need not be restricted to common lengths such as 2-foot and 4-foot. A modern manufacturing technique, such as extrusion coupled with solid-state technology, may allow great flexibility in the length. For very long lengths, multiple units can be joined together to form any length required for the application.

Additional aspects and advantages of the present disclosure will become readily apparent to those skilled in this art from the following detailed description, wherein only exemplary embodiments of the present disclosure are shown and described, simply by way of illustration of the best mode contemplated for carrying out the present disclosure. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows a high level schematic of a lighting system in accordance with an embodiment of the invention.

FIG. 2 shows an angled view of a linear pendant luminaire in accordance with an embodiment of the invention.

FIG. 3 shows another angled view of a linear pendant luminaire.

FIG. 4 shows an end view of a linear pendant luminaire.

FIG. 5 shows a side view of a linear pendant luminaire.

FIG. 6 shows an example of a linear pendant luminaire with side lighting.

### DETAILED DESCRIPTION OF THE INVENTION

The invention provides systems and methods for providing illumination. A linear pendant luminaire may provide light to an area. Various aspects of the invention described herein may be applied to any of the particular applications set forth below or for any other types of lighting configurations. The invention may be applied as a standalone device or method, or as part of an integrated lighting system. It shall be understood that different aspects of the invention can be appreciated individually, collectively, or in combination with each other.

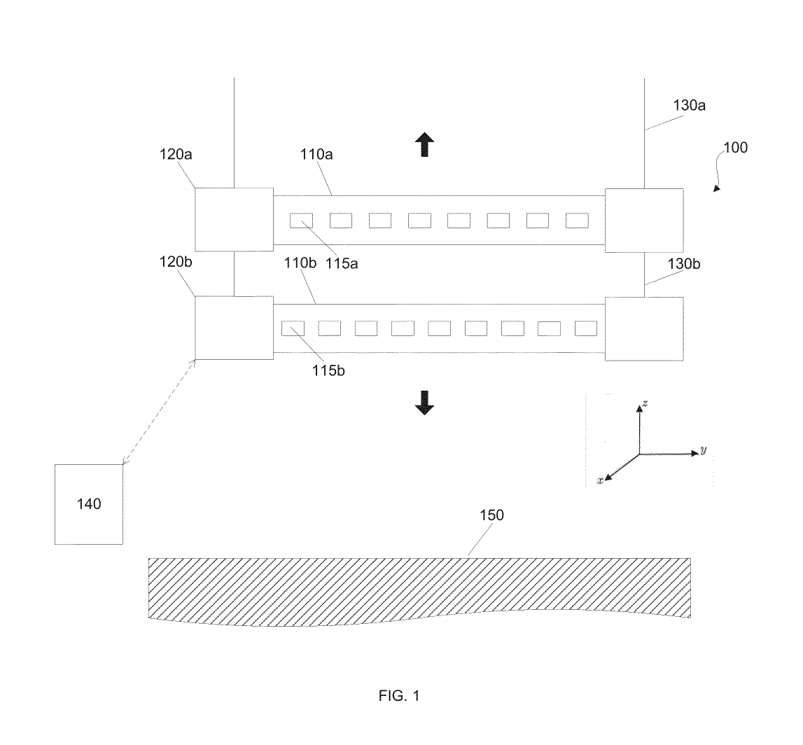

FIG. 1 shows a high level schematic of a lighting system in accordance with an embodiment of the invention.

The system may include a luminaire 100, in accordance with an embodiment of the invention. The luminaire may be configured to function as a fluorescent tube replacement, or may be any type of lighting unit configured to illuminate an area or region. The luminaire may it include a body 110a, 110b and one, two, or more end caps 120a, 120b. In some embodiments, the luminaire may include a power supply or a complete optical system that defines the final light distribution to an environment (e.g., room), or may include a mechanical structure to allow it to attach to a structure (e.g., room, building), such as one or more suspension-based support 130a, 130b. In some embodiments, the luminaire may be a pendant luminaire that may hang from a ceiling or other overhanging support. A suspension-based support may permit the luminaire to hang. In some other embodiments, the luminaire may be a self-ballasted luminaire, such as compact fluorescent or LED, or some luminaires may be used in configurations that do not require additional optics. In additional embodiments, luminaires may be provided so that they can be hung from wires tensioned across some distance to provide ad hoc mechanical support and electrical connection. In some embodiments, a luminaire may be connected directly to a mains electrical wiring. A suspension based support may aid in connecting to the electrical wiring.

In one example, the body 110a, 110b may be an elongated body. The luminaire may be a linear luminaire and/or have a linear configuration. The body length to width ratio may be greater than, less than, or equal to about 500:1, 300:1, 200:1, 100:1, 90:1, 80:1, 70:1, 60:1, 50:1, 40:1, 30:1, 20:1, 10:1, 8:1, 7:1, 6:1, 5:1, 4:1, 3:1, 2:1. The body length may be greater than, less than, or equal to about 3 inches, 6 inches, 9 inches, 1 foot, 18 inches, 2 feet, 30 inches, 3 feet, 42 inches, 4 feet, 5 feet, 6 feet, 7 feet, 8 feet, 10 feet, 15 feet, or any other length. The elongated body may include an optical system which may include one or more optical elements. In some embodiments, the optical system may include a window. The optical system may also include reflector, or other optical element as discussed elsewhere herein.

The elongated body may have any shape. In some embodiments, the elongated body may have a semi-cylindrical shape (e.g., with one curved side and one flat side). In other embodiments, the elongated body may have a cylindrical or prismatic shape. In some embodiments, the body sides may be exposed to ambient air. In one example, the flat side and the curved side of a body may be exposed to ambient air. The sides of the body may be exposed without requiring any fins or protrusions on the exterior of the body. Extra external heat dissipating mechanisms may not be required on the body.

In alternative embodiments the body need not be an elongated body. The body may have a length to width ratio that is less than or equal to 10:1, 8:1, 6:1, 5:1, 4:1, 3:1, 2:1, 3:2, 4:3, or 1:1. The body may have a rounded shape without any corners or edges. Alternatively, the body may have one, two, three, four, or more edges. The body may have one, two, three, four, five, six, seven, eight, nine, ten, eleven, twelve, or more corners.

A body 110a, 110b may have one or more light emitting elements 115a, 115b. The light emitting elements may be any illumination source known in the art. For example, the light emitting elements may include a light emitting diode (LED). A light emitting element may include an LED package. A light emitting element may or may not be a phosphor converted LED. The light emitting element may comprise an LED chip and an encapsulant and/or other lenses or reflectors that function as a primary optics. In some embodiments, a light emitting element may comprise a phosphor proximate to the LED chip configured to convert a portion of the light emitted by the LED chip to a longer wavelength. Alternatively, the light emitting element need not have a phosphor coated thereon. A light emitting element can be formed of a semiconductor material with a primary optic. In some embodiments, a light emitting element may be a point source or substantially point source light emitting element. The light emitting element may provide isotropic light.

In some embodiments, a light emitting element may be a top emitting LED. In other embodiments, a light emitting element may be a side emitting LED or a bottom emitting LED. The light emitting element may direct light in any or multiple directions. In some instances, the light emitting element may have a primary direction of illumination. For example, the primary direction of illumination of a top emitting LED may be the direction of the top face of the LED. Even if light is emitted isotropically, a body or other portion of the light emitting element may block the light in certain directions, so that the light may have a primary direction of illumination.

In alternative embodiments, the light emitting elements may be cold cathode fluorescent lamps (CCFLs) or electroluminescent devices (EL devices). Cold cathode fluorescent lamps may be of the type used for backlighting liquid crystal displays and are described generally in Henry A. Miller, Cold Cathode Fluorescent Lighting, Chemical Publishing Co. (1949) and Shunsuke Kobayashi, LCD Backlights (Wiley Series in Display Technology), Wiley (Jun. 15, 2009), which are hereby incorporated by reference in their entirety. EL devices include high field EL devices, conventional inorganic semiconductor diode devices such as LEDs, or laser diodes, or solid state devices with radiation patterns in between art LED and laser diode such as those that may employ a resonant cavity or photonic lattice, as well as OLEDs (with or without a dopant in the active layer). A dopant refers to a dopant atom (generally a metal) as well as metal complexes and metal-organic compounds as an impurity within the active layer of an EL device. Some of the organic-based EL device layers may not contain dopants. The term EL device excludes incandescent lamps, fluorescent lamps, and electric arcs. EL devices can be categorized as high field EL devices or diode devices and can further be categorized as area emitting EL devices and point source EL devices. Area emitting EL devices include high field EL devices and area emitting OLEDs. Point source devices include inorganic LEDs and top-, bottom-, edge- or side-emitting OLED or LED devices. High field EL devices and applications are generally described in Yoshimasa Ono, Electroluminescent Displays, World Scientific Publishing Company (June 1995), D. R. Vij, Handbook of Electroluminescent Materials, Taylor & Francis (February 2004), and Seizo Miyata, Organic Electroluminescent Materials and Devices, CRC (July 1997), which are hereby incorporated by reference in their entirety. LED devices and applications are generally described in E. Fred Schubert, Light Emitting Diodes, Cambridge University Press (Jun. 9, 2003). OLED devices, materials, and applications are generally described in Kraft et al., Angew. Chem. Int. Ed., 1998, 37, 402-428, and Z., Li and H. Meng, Organic Light-Emitting Materials and Devices (Optical Science and Engineering Series), CRC Taylor & Francis (Sep. 12, 2006), which are hereby incorporated by reference in their entirety.

The light emitting elements can produce light in the visible range (e.g., 380 to 700 nm), the ultraviolet range (e.g., 315 to 400 nm; UVB: 280 to 315 nm), and/or near infrared light (e.g., 700 to 1000 nm). Visible light may correspond to a wavelength range of approximately 380 to 700 nanometers (nm) and is usually described as a color range of violet through red. The human eye is not capable of seeing radiation with wavelengths substantially outside this visible spectrum such as in the ultraviolet or infrared range, but these wavelengths may be useful for other applications, such as exciting fluorescence, phototherapy, security, disinfection, communications, plant growth, identification, or inspection applications. Furthermore, ultraviolet light may be down converted by a luminescent material in the lamp. In some embodiments, a luminaire may have a luminscent material thereon. The luminescent material may be a luminescent paint or coating. The luminescent material may be a fluorescent material, photoluminescent, chemiluminscent material, bioluminscent material, or any other type of luminescent material. In some instances, an ultraviolet wavelength may excite fluorescent materials, which may highlight an appearance of the object under illumination. The ultraviolet light may be UVA (ultraviolet A), UVB (ultraviolet B)light, or UVC (ultraviolet C) light.

The visible spectrum from shortest to longest wavelength is generally described as violet (approximately 400 to 450 nm), blue (approximately 450 to 490 nm), green (approximately 490 to 560 nm), yellow (approximately 560 to 590 nm), orange (approximately 590 to 620 nm), and red (approximately 620 to 700 nm). White light is a mixture of colors of the visible spectrum that yields a human perception of substantially white light. The light emitting elements can produce a colored light or a visually substantially white light. Various light emitting elements can emit light of a plurality of wavelengths and their emission peaks can be very broad or narrow. In one example, the emission peaks may be greater than, less than, or equal to about 100 nm, 50 nm, 30 nm, 20 nm, 15 nm, 10 nm, 5 nm, or 1 nm. In some examples, the entire wavelength emission range may be greater than, less than, or equal to about 500 nm, 400 nm, 300 nm, 200 nm, 150 nm, 100 nm, 50 nm, 30 nm, 20 nm, 15 nm, 10 nm, 5 nm, or 1 nm. Light emitting elements may be white LEDs or blue LEDs for example. Furthermore, in a single lighting unit, light emitting elements may comprise a combination of colors such as red and white LEDs; red, green and blue LEDs; or red, blue, green, amber (yellow) and white LEDs; or any number of colors needed to best represent the range of spectral power distributions and/or color qualities desired for the application. In some embodiments unmixed color may be emitted along the length of the luminaire. In some instances, one or more levels of the luminaire, unmixed color may be emitted along the length. For each level of the luminaire unmixed color may be emitted.

In some embodiments, a material may be provided that may convert wavelengths emitted by the one or more light emitting elements. The material may function as a filter. The material may function to change the direction or dispersion of a light beam. Alternatively, the material may receive the light emitting elements at a first wavelength and emit light at a second wavelength. In some embodiments, the second wavelength may be a longer wavelength than the first wavelength. Alternatively, the second wavelength may be a shorter wavelength than the first wavelength. The material may be a wavelength down-converter configured to interact with the light emitted by the one or more light emitting elements (e.g., increase the wavelength). The material may be a luminescent material as described above. The material may be a phosphor or a quantum dot. The material may be located remotely from the one or more light emitting elements. The material may optionally not contact the light emitting elements. The material may be disposed on a surface that is at a distance away from the light emitting elements.

A luminaire 100 may include light emitting elements 115a, 115b that all emit wavelengths within the same range. Alternatively, light emitting elements that emit light in different wavelengths may be used. For example, a circuit board or other support may support one or more color of LEDs.

In some embodiments, it may be desirable for a lighting unit to include both white and red LEDs. In some embodiments, a combination of LEDs may be used to form a white light. In some embodiments, one or more cool white LEDs and one or more red LEDs (e.g.; having a wavelength in the range of about 620 to 700 nm) may be provided on a lighting unit. In another embodiment, one or more mint green or greenish white LEDs and one or more red LEDs (e.g., having a wavelength in the range of about 600 to 700 nm) may be provided on a lighting unit. The LEDs having different wavelengths may be alternatingly positioned on the lighting unit. For example, white and red LEDS, or green and red LEDs may be alternatingly positioned along an edge of a circuit board. In other embodiments, groups of white and red LEDS or groups of green and red LEDs may be alternatingly located along an edge of a circuit board. In some embodiments, a lighting unit may include both blue and red LEDs, or blue, white, and red LEDs. In some embodiments, the proportion of white LEDs to red LEDs may be greater than, less than, or equal to about 20:1, 15:1, 10:1, 7:1, 5:1, 3:1, 2:1, 1:1, 1:2, 1:3, 1:5, or 1:10. In some examples, the proportion of white LEDs to red LEDs may fall between about 5:1 and 1:1. The color and proportion of different groups of LEDs may be configured to achieve a desired correlated color temperature (CCT), Duv, color rendering index (CRI), color quality scale (CQS), or other color specifications that may be required to meet Energy Star requirements, for example. Different groups of LEDs may be driven separately to preserve color over lifetime and temperature. Furthermore, separately driving different groups of LEDs may allow color tuning and dimming features. Groups of light emitting elements may or may not comprise light emitting elements of the same color.

There may be a desire to have a choice of the CCT that has a chromaticity close to the black body locus in the range of 2700K to 6500K. However, color temperatures beyond this range and chromaticities well above or below the black body locus can also be desirable. Similarly, the spectral power distribution (SPD) of a black body radiator, while in general of interest, is not the only SPD that is desirable. One example is the SPD of daylight which is generally not shaped like a black body radiator nor is its chromaticity usually located on the locus. Therefore its desirable for a light source to be able to accommodate a wide variation in both SPD and chromaticity as the application dictates while at the same time keeping light source to light source variations at a minimum. While it is common for light sources today to have a fixed CCT and SPD, it is also desirable to have a light source with an adjustable spectrum.

In some embodiments, the light emitting elements with various input spectrums (different colors) can be component parts of the light source. These different colors could be visible in the light source unless additional optical elements or tools are employed. This conspicuous variation of color may be desirable both for aesthetic reasons and efficiency reasons. Other examples of non-black body SPDs include enhancing the blue portion of the spectrum to decrease melatonin and increase wakefulness, enhancing the red portion of the spectrum to allow melatonin to increase naturally to prepare for sleep in humans. Beyond preparing humans for sleep or wakefulness, there are more generally designer spectrums with specific illumination goals that are of commercial interest. For example a spectrum that enhances color contrast for retail product displays of all types or one optimized for product inspections of all types or one that improves worker productivity or student concentration levels. Other examples are spectrums that cause fluorescence. These may be used, for example, to distinguish between a bacterial, fungal, and other infections or medical conditions. These are just some examples and should not limit the scope of designer spectrums. There are also lighting applications beyond human consumption. For example emphasizing the blue and red portions of the spectrum for plants or the spectrum appropriate for health, reproduction, and growth in land, air, and water based animals. Thus, the spectrum for the light emitting elements of the lamp can be selected to provide the desired illumination for various applications.

Light emitting elements may have a spectral power distribution. The spectral power distribution may have an excess of energy in a particular color portion. For instance, there may be an excess of energy in the cyan portion of the spectrum compared to a thermal radiator. This may enhance wakefulness in humans. The spectral power distribution may have a deficit of energy in a particular color portion. For instance, there may be a deficit of energy in the cyan portion of the spectrum compared to a thermal radiator to promote pre-sleep in humans.

The lamp may be color-tunable for different applications. In some instances, lamps may be provided with different color spectrum emissions for different applications. In other instances, an individual lamp may be adjustable between different color spectrum emissions for different applications. For example, a user may select a sleep mode to provide an illumination spectrum that gets a human prepared for sleep, or may select a waking mode to provide a different illumination spectrum that keeps a human awake. In some embodiments, the color spectrum may be used to simulate natural daylight. The color spectrum may be used to simulate natural daylight at specified times of the day (e.g., simulate dawn light, morning light, mid-day light, afternoon light, dusk light). The color spectrum may be used to simulate natural daylight under different weather conditions (e.g., sunny, cloudy, foggy, rainy, snowy). In some instances, the color spectrum may be used to simulate natural daylight for specific seasons e.g., summer, autumn, winter, spring). Similarly, the user may select between different modes for different applications such as a first illumination spectrum for growing plants and a second illumination spectrum for interior lighting for humans. An input region may be provided through which a user may select a mode for a lamp to operate. For example, a switch, button, touchscreen, lever, or other input mode may be provided through which a user may select an operational mode for a lamp, which may dictate the color spectrum and/or intensity emitted by the lamp. Input may also be provided by a personal device, such as a phone or tablet. Input may also be provided by a spectral sensor located to receive daylight. Light spectrum characteristics may be individually controlled as described in greater detail elsewhere herein.

The light emitting elements 115a, 115b may have any configuration. For example, the emitting elements may form one row, two rows, three rows, or more rows, extending along the length of an elongated body 110a, 110b. The light emitting elements may form an array or staggered rows. The light emitting elements may have a circular, curved pattern, or other arrangements suitable for the application. The light emitting elements may or may not be evenly spaced apart from one another. In some instances, the light emitting elements may be spaced apart from one another by a distance greater than, less than, or equal to about 1 mm, 3 mm, 5 mm, 7 mm, 1 cm, 1.2 cm, 1.5 cm, 1.7 cm, 2 cm, 2.5 cm, 3 cm, 4 cm, 5 cm, 7 cm, or 10 cm. In some instances, the distance between the light emitting elements may fall between two of the distances described herein. The light emitting elements may be spaced sufficiently far apart to permit heat generated by the light emitting elements to substantially dissipate.

A luminaire 100 may include one or more circuit boards. One or more light emitting elements 115a, 115b may be provided on the circuit board. The circuit board may be a printed circuit board (PCB) or flex circuit. Any circuit board material known in the art may be used. One, two or more light emitting elements may be provided on a circuit board. Preferably, a plurality of light emitting elements are supported by a circuit board. The circuit board may also support and provide electrical connections and/or between the light emitting elements. The circuit board may provide an electrical connection between one or more light emitting elements and a power source.

The circuit board may or may not be formed of an optically transmissive material. The circuit board may be formed from an opaque material, a translucent material, or a transparent material. The circuit board may be at least partially optically transmissive (e.g., at least 10%, 20%, 30%, 40%, 50%, 60%, 70%, 80%, 90%, 95%, or 99% optically transmissive). In some instances, the material used to form the circuit board may be glass or plastic. The circuit board may comprise conductors. One or more light emitting elements can be mounted directly onto the circuit board. The light emitting elements may be electrically interconnected with conductors. In some embodiments, the conductors may be transparent conductors such as indium tin oxide (ITO) or opaque conductors such as copper, tin, solder, nickel, iron, palladium, silver, or gold, in the form of wires or films (thick or thin). In one example, Noritake or other thick film paste may be used. In some embodiments, a circuit board may be mounted or supported by a supporting optical element. The circuit board may be separable from the supporting optical element. The circuit board may be integrally formed with the supporting optical element. A supporting optical element may function as the circuit board. The supporting optical element may be at least partially optically transmissive. In some embodiments, a circuit board and/or supporting optical element may be substantially flat. Alternatively, the circuit board and/or supporting element may be curved. The circuit board and/or supporting optical element may or may not be flexible.

In some instances, the light emitting elements 115a, 115b may have a primary direction of illumination. For example, the light emitting elements may be light-emitting diodes (LEDs) that are directed in a primary direction. For example, relative to a fixed reference frame, the LEDs may he directed upwards (positive Z direction). The LEDs may be top-emitting LEDs. The light emitting elements may be solid state light emitting elements. In some implementations, the light emitting elements may be LEDs, organic light-emitting diodes (OLEDs), light emitting plasma (LEP), light emitting capacitor or cell (LEC), or any other types of light emitting elements. The primary direction of illumination for the light emitting elements may optionally be different from he primary direction of illumination of the luminaire 100. In one example, relative to the fixed reference frame, the luminaire may be primarily directing illumination downwards (negative Z direction). The light emitting elements may primarily direct light in a direction opposite the primary direction of illumination of the luminaire. Alternatively, they may be directing light in the primary direction of illumination of the luminaire. Alternatively, the light emitting elements may direct light in a different direction relative to the primary direction of illumination of the luminaire (e.g., at an angle greater than, less than, or equal to 15 degrees, 30 degrees, 45 degrees, 60 degrees, 75 degrees, 90 degrees, 105 degrees, 120 degrees, 135 degrees, 150 degrees, 165 degrees, 180 degrees). In some embodiments, the fixed reference frame may correspond to a surface of the environment being illuminated (e.g., Z axis may be substantially orthogonal to a ground, floor, wall, structure, ceiling, ramp, surface). The fixed reference frame reference frame may correspond to the direction of the Earth's gravity (e.g., Z axis may be substantially parallel to the direction of gravity, positive Z direction opposing gravity).

In some embodiments, a luminaire may have multiple bodies. For example, a first body 110a and a second body 110b may be provided for a luminaire. Any number of bodies may be provided (e.g., one body, two bodies, three bodies, four bodies, five bodies, six bodies, or more). In some instances, each of these bodies may be substantially parallel. For instance, longitudinal axes extending along the lengths of the bodies may be parallel to one another. Alternatively, they may be at any angle relative to one another. In one example, two bodies may run substantially parallel to one another so that the first body is located above the second body. The second body may be suspended beneath the first body. In some instances, one or more end caps 120a of a first body may be positioned above one or more end caps 120b of a second body. In some instances, one or more end caps of the second body may be suspended from one or more end caps of the first body. Optionally a suspension support 130b may hold the end caps of the second body beneath the end caps of the first body.

In some instances, each body may have a primary direction of illumination. In some embodiments, one or more of the bodies may have different primary directions of illumination. In some instances, some of the bodies may have opposing primary directions of illumination. For example, a first body 110a tray have a primary direction of illumination that is upwards. A second body 110b may have a primary direction of illumination that is downwards. Optionally, one or more of the bodies may have primary directions of illumination that are the same. In some instances, the primary directions of illuminations between bodies may vary by any angle (e.g., at an angle greater than, less than, or equal to 15 degrees, 30 degrees, 45 degrees, 60 degrees, 75 degrees, 90 degrees, 105 degrees, 120 degrees, 135 degrees, 150 degrees, 165 degrees, 180 degrees).

As previously described, a light emitting element 115a, 115b may emit light in multiple directions, or may have a primary direction of illumination. The light emitting element primary direction of illumination may or may not correspond to a primary direction of illumination of a body 110a 110b. When multiple bodies are provided with different primary directions of illumination, the corresponding light emitting elements may be directed in relation to the primary direction of illumination for the body. For example, in one implementation, when a first body 110a has an upwards primary direction of illumination, the light emitting elements 115a of the first body may be directed downward, so that light is reflected upwards. When a second body 110b has a downwards primary direction of illumination, the light emitting elements 115b of the second body may be directed upward, so that light is reflected downwards. In some instances, the light emitting elements may be directed away from the primary direction of illumination of the bodies to prevent a direct line of sight to the directly emitted light. Alternatively, the light emitting elements may be directed toward the primary directions of illumination of the bodies.

One or more modifying optical element may be used to redirect light emitted from one or more light emitting elements. The modifying optical element may alter the angle light of the path by at least 5 degrees, 10 degrees, 20 degrees, 30 degrees, 40 degrees, 50 degrees, 60 degrees, 70 degrees, 80 degrees, 90 degrees, 120 degrees, 150 degrees, 170 degrees, or 180 degrees. The modifying optical element may be at least partially reflective. Alternatively, the modifying optical element need not be reflective. The modifying optical element may be a diffuse or specular reflector. The modifying optical element may or may not be optically transmissive. The modifying optical element may be opaque, translucent, or transparent. The modifying optical element may be a lightguide. The modifying optical element may or may not reduce pixelation from the one or more light emitting elements.

In some embodiments, the modifying optical element may have a curved shape. The modifying optical element may have a U or V shaped cross-section. The modifying optical element may have a trough-shaped cross-section. The modifying optical element may have one or more wings. In one example, the modifying optical element may have a first wing and a second wing. Each wing may be curved. A modifying optical element with wings may have a curved shape. A structural stiffener may be used to connect the wings. A space may be formed between the structural stiffener and the first and second wings. The modifying optical element may extend along a length of a luminaire. Alternatively, the modifying optical element may only be provided along a portion of the length of the luminaire. The space between the structural stiffener and the first and second wings may form a channel along the length of the luminaire. The channel may be a substantially closed channel.

One or more U-shaped or V-shaped protrusions may be provided the proximity of one or more light emitting elements. The protrusions may be provided above the light emitting elements. The protrusions may be provided in the path of primary illumination from the light emitting elements. The protrusions may be configured to direct light away from the light emitting elements. The protrusions may be part of the modifying optical element, the supporting optical element, or may be a separate component.

A modifying optical element may contact a supporting optical element and/or circuit board. Any description herein of the supporting optical element may be applied to that of the circuit board. In one instance, the supporting optical element may be substantially flat while the modifying optical element may have a curved shape. Opposing sides of the supporting optical element may contact the modifying optical element. The sides may extend along the length of the supporting optical element. The modifying optical element coupled to the supporting optical element may enclose at least a portion of the luminaire. The luminaire may be at least partially enclosed by the modifying optical element and the supporting optical element. One or more light emitting elements may be at least partially enclosed by the modifying optical element and the supporting optical element.

One or more optical elements of the luminaire may include a lens or grating the may extend light emitted from the one or more light emitting elements along a length of the luminaire. The one or more optical elements may be an additional optical element to the modifying optical element or the supporting optical element. Alternatively, the one or more optical elements may be the modifying optical element or the supporting optical element.

The systems and methods provided herein may be configured to provide uniform light. The configuration of the lighting unit may enable it to deliver light with little or no pixelation. The light illuminated in a direction of illumination may be continuous. The continuous light may have no pixelation or distinguishable subsections. Indirect lighting configurations as described and/or diffuse reflectors may be used to provide the substantially unpixelated light. Light emitted by multiple light emitting elements may be continuous over an extended region and are not divided into many small sub-sections or pixels that can be independently activated to form an image. In some embodiments, light delivered to an illumination area may not vary substantially over the area. The light intensity over an illumination area may optionally not vary substantially. For instance, the light intensity may not vary by more than 1%, 3%, 5%, 7%, 10%, 12%, 15%, 20%, 25%, or 30% in a primary direction of illumination. In some instances, the illumination may be less than or equal to 0.1, 0.5, 1, 2, 3, 4, or 5 JND (just noticeable difference). Typically, professionals may be able to see about 1 JND, and 3 JND may be considered ok for the general public to not notice or complain. Over an area of 0.1 square meter, 0.5 square meter, 1 square meter, 2 square meters, 3 square meters, 5 square meters, or 10 square meters, the light intensity over any portion of the area may not vary substantially. For instance, the light intensity may not vary by more than 1%, 3%, 5%, 7%, 10%, 12%, 15%, 20%, 25%, or 30% over any of the areas described herein. For instance, the illumination may be less than or equal to about 0.1, 0.5, 1, 2, or 3 JND over any of the areas described herein. Any of the features and elements described herein may be useful for providing non-pixelated light

In some instances, the light emitting elements 115a, 115b may be partially or completely enclosed within the body 110a, 110b. The light emitting elements may be surrounded by one or more optical elements. In some instances, one or more of the optical elements may permit the illumination from the light emitting elements to be redirected to the primary direction of illumination of the bodies 110a, 110b.

Optionally, the light emitting elements within different bodies (e.g., first body 110a, 110b) may be the same type or emit lights having similar characteristics. Alternatively, light emitting elements within different bodies may be of different types, or may emit lights having different characteristics. For example, a first body may emit light primarily at a first wavelength while a second body may emit light at primarily a second wavelength, which may be different from the first wavelength. The first body may emit light having a first overall intensity while the second body may emit light having a second overall intensity, which may be different from the first intensity.

The luminaire 100 may include one or more end caps 120a, 120b connected to the luminaire bodies 110a, 110b. The end caps may be mechanically connected to the luminaire body. The end caps may be electrically connected to one or more light emitting elements 115a, 115b. In some instances, the luminaire may have two ends, with end caps at each end. Each body may have two ends, where one or more end caps at each end. The end caps may be at opposing ends of a linear elongated body. In alternative embodiments, the body may be bent, curved, form a U-shape, form a circular shape, branch off into additional ends, form a cross-shape, or any other shape. When multiple bodies are provided, they may each have the same shape, or may have differing shapes. Any number of end caps may be selected to correspond to the number of ends of provided by the luminaire body. The end caps may be configured to mechanically and/or electrically couple the luminaire 100 to a power source or light receptacle. Alternatively, coupling can be achieved without end caps.

The end caps 120 may be electrically connected to a power source via a support 130a, 130b, which may permit the luminaire to be engaged in a lighting system. Coupling may be achieved, for example, through the use of wires or other conductive components that may be used to suspend a pendant luminaire. The electrical connectors may or may not be formed from an electrically conductive material. In some instances, one, two, or more conductive components may be provided per end cap. The conductive components may or may not be parallel, and may be insulated from one another (e.g., wires insulated from one another). In one embodiment, at least one of the end caps may be used only for mechanical coupling. Alternatively, other electrical connection mechanisms may be utilized.

To increase or maximize efficiency, an optical can be designed to minimize or reduce the number of photon bounces from a light emitting element to exiting the light source. After reducing or minimizing the number of bounces, the surfaces redirecting the light can be of the best quality (e.g., highest or increased reflectivity or transmission) that can be economically applied for a given application. In general the optical tools or elements available include reflectors (e.g., including diffuse and specular), refractors (e.g., lenses including imaging, non-imaging, and Fresnel), diffractors (e.g., including gratings and nano patterns), diffusers (e.g., including bulk and surface), filters (e.g., including high pass, low pass, and notch), and/or light guides (e.g., including flat and curved). A special case of an optical element is a clear window or transparent cover. A window can be “optical” in that it passes visible radiation with little attenuation but does not have optically transformative properties, commonly referred to as secondary optics, that the other aforementioned optical elements have. Optical surfaces may or may not have anti reflective coatings to increase efficiency. These tools or elements can be used alone or in any combination to optimize or improve the performance and cost of the design for the application.

An external device 140 may optionally communicate with a luminaire 100 in the lighting system. The external device may optionally provide a signal to the luminaire. The signal may include data may be used by the luminaire in its operation. The signal may include a command that controls operation of the luminaire. In some instances, a signal may be provided from the luminaire to the external device. In some instances, two-way communication between the luminaire and the external device may be provided.

The luminaire may optionally include one or more infrared light emitting elements. In some instances, an infrared light emitting element may be used for communication between the luminaire and a device. In some instances, the device may be the external device used to provide a signal to the luminaire. In other embodiments, wireless signals may be transmitted between the device and the luminaire. For instance, WiFi or radiofrequencies may be used. In some instances, wired connections may be provided for communications between a device and the luminaire. The luminaire may have a wired or wireless communication interface.

In one example, the external device 140 may be a controller of the luminaire 100. The controller may optionally be portable or may be provided at a fixed location. In some instances, a user may provide an input to the controller to control operation of the luminaire. A controller may have a user interface capable of displaying information to the user and/or receiving an input from the user. In some examples, the user interface may be a touchscreen, button, keyboard, mouse, audio sensor, camera, or have any other configuration.

The controller may control an intensity of light emitted by the luminaire. In another example, the controller tray control the overall wavelengths of light emitted by the luminaire. In yet another example, the controller may control light distribution from the luminaire. Light emitted by each body 110a, 110b of the luminaire may be controlled together, or may be controlled separately. For example, light emitted by a first body 110a may be controlled separately from light emitted by a second body 110b. In one example, intensity of light from an upper body 110a of a luminaire may be controlled separately from intensity of light from a lower body 110b of the luminaire.

In some instances, intensity of light may be controlled by controlling intensity emitted by each light emitting element 115a, 115b. Alternatively, intensity of light emitted by a body may be adjusted by controlling which light emitting elements within the body are turned on or off. Turning more light emitting elements on may result in overall greater light intensity. The distribution of light may depend on which light emitting elements are turned on or off along the length of the body. In some instances, optics may be adjusted in response to a signal from a controller to aid in changing distribution of light. In some instances, the overall wavelength of light emitted by a body may be controlled by turning on or off different light emitting elements that emit at various wavelengths. For example, if a body has both white and red LEDs, turning on more red or fewer whites may result in a warmer color.

Thus, each body of the luminaire may respond separately to a command provided by a controller to control a characteristic of light emitted by the body. Each body may respond with aid of a processor and without requiring further human intervention at the luminaire.

In some embodiments, the external device 140 may be a sensor. The sensor may transmit information to the luminaire 100. For example, the sensor may be a light sensor. Based on the ambient light that is provided within the room, the light output of the luminaire may be adjusted. For example, if it already very bright (e.g., daytime) within a room, the luminaire may be dimmed or turned off. If the room is getting darker (e.g., nighttime), the luminaire may be turned on brighter. Such a determination how to adjust the spectral output from a luminaire may be performed on-board the luminaire. Alternatively, such determination how to adjust the spectral output may occur on-board an external device, such as a controller or sensor, and may be communicated as a command signal to the luminaire. In some instances, some calculation may occur off-board the luminaire and some may occur on-board the luminaire.

In some embodiments, a luminaire may have a transceiver capable of receiving a signal from an external device. The luminaire may be capable of communicating with the external device wirelessly, or through a wired connection. The luminaire may have one or more processors that may receive and/or analyze the command signal or data and control operation of the luminaire accordingly. In some instances, the processors may be provided at one or more of the end caps of the luminaire. In some embodiments, one or more of the bodies of the luminaire may have one or more processors that may perform this function. The luminaire may have one or more memory units that may store information, or no transitory computer readable medium comprising code, logic, or instructions to perform one or more steps, such as controlling operation of the luminaire. The luminaire may also receive and/or transmit information with a remote medium or device such as the cloud, either by wires or wirelessly to for both illumination and other purposes. The luminaire may also exchange information with sensors, such as biometric information, with either or both the local ecosystem and remote ecosystems. The information contained in these transactions may be valuable beyond the basic function of the luminaire to provide the desired illumination. For example, the information may be useful for occupant distribution over space and time, human biometric detection and feedback, and interaction with other building control systems that may exist, such as HVAC and security.

Alternatively, no external device may be needed by the luminaire. For example, the luminaire may have an on-board system that may receive commands from a user. The luminaire may also have on-board sensors that may detect environmental conditions which may aid in tuning of the light emitted by the luminaire. In some instances, the luminaire may have an on-board clock that may be used to aid in controlling the light emitted by the luminaire. For example, based on time of day, or day of the year, the luminaire light output may be dynamically adjusted.

The luminaire 100 may be used to illuminate a target region 150. In some embodiments, a target region may be a surface or region. In some instances, a target region may be a workspace or working area. In one example, the luminaire may be a pendant luminaire that is suspended from a ceiling or other overhanging surface. The target region may be provided beneath the suspended pendant luminaire.

In some embodiments, it may be desirable for the luminaire 100 to be close to the target region 150 or surface. Any distances may refer to a center of mass of the luminaire, or from the lowest surface of the luminaire. If multiple bodies are provided at different heights, this may refer to the lower body 110b of the luminaire.

In some examples, the luminaire may be within 10 feet, 8 feet, 7 feet, 6 feet, 5 feet, 4 feet, 3 feet, 2 feet, 1 foot, 6 inches, or 1 inch from the target region. In some embodiments, the ratio of the length of the luminaire to the distance from the luminaire to the target region may be greater than or equal to about 10:1, 7:1, 5:1, 4:1, 3:1, 2:1, 1:1, 1:2, 1:4, or 1:10. In some other examples, the ratio of the distance from the luminaire to the target region to the distance from the luminaire to an overhanging support such as a ceiling may be less than or equal to about 1:10, 1:7, 1:5, 1:4, 1:3, 1:2, 1:1, 2:1, 3:1, 4:1, or 5:1.

The height of the luminaire may be adjustable. The distance of the luminaire from a target region may be adjustable. The distance may be manually adjusted or may be adjusted with aid of one or more actuators, such as motors.

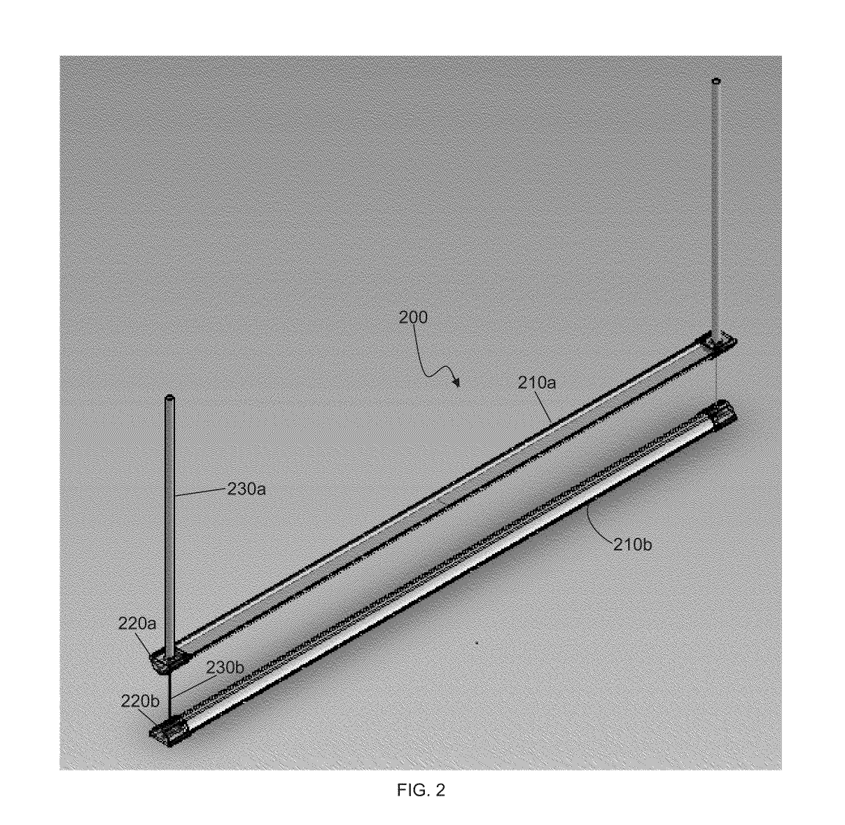

FIG. 2 shows an angled view of a linear pendant luminaire 200 in accordance with an embodiment of the invention. The linear pendant luminaire may have an upper body 210a, and a lower body 210b. The upper body may have one or more end caps 220a, and the lower body may have one or more end caps 220b. An upper suspension mechanism 230a may support the upper body of the luminaire. A lower suspension mechanism 230b may support the lower body of the luminaire.

An upper body 210a and lower body 210b of a luminaire may be provided at different heights along the luminaire. The lower body may be directly beneath the upper body. The lower body and upper body may both be elongated shapes. The lower body and upper body may have similar form factors. In some instances, the lower body may direct light primarily downward while the upper body may direct light primarily upward. In some instances, one or more optical elements may be used in each body to direct light to a desired distribution. In some instances, light from a light emitting element may be reflected at least once before leaving the body. Alternatively, light from a light emitting element may leave the body directly without being reflected. Light from a light emitting element may be modified by passing through an optical element. In some examples, a lower body may have a window or pane on its bottom surface. Alternatively, the lower body may be open on its bottom surface. An upper body may have a window or pane on its upper surface. Alternatively it may be open on its upper surface. In some instances, a lower body may have a curved upper surface. The curved upper surface may be substantially opaque. The upper body may have a curved lower surface. The curved lover surface may be substantially opaque.

One or more end caps 220a, 220b may be provided at the ends of bodies. In some instances, each body may have two end caps, one at each end. One or more of the end caps may communicate with one another. Alternatively, they may operate independently of one another. One or more end caps may provide electrical connections between a power source and one or more light emitting elements in the body. In some instances, the end caps may control the light emitting elements in the body, thereby controlling the spectral distribution of light by the body. An upper end cap 220a may control light emitted by an upper body 210a while a lower end cap 220b may control light emitted by a lower body 210b. Any number of bodies may be provided for a luminaire, and each body may be controlled by one or more end caps of the body. Alternatively, a single end cap may control light emitted by multiple bodies. Other end caps may optionally be slaves to a master end cap.

One or more suspension mechanisms 230a, 230b may be provided for the luminaire. The height of the luminaire may be adjustable. The suspension mechanisms may permit the luminaire bodies to change height. In some instances, each suspension mechanism may operate independently of one another. For example, an upper suspension mechanism 230a may adjust the height of an upper body 210a without adjusting a height of the lower body. A lower suspension mechanism 230b may adjust the height of the lower body 210b without adjusting the height of the upper body. In other embodiments, the action of a :suspension mechanism may affect multiple bodies. For example, an upper suspension mechanism 230a may affect the height of the upper body 210a and the lower body 210b together. The lower suspension mechanism may affect the height of the lower body relative to the upper body.

Some embodiments may provide two suspension mechanisms per body of the luminaire. For example, each elongated may have a suspension mechanism at or near each end. For instance, an upper body may have a first upper suspension mechanism at a first end and a second upper suspension mechanism at a second end. Alternatively, any number of suspension mechanisms may be provided per body (e.g., one, two, three, four, five, six, seven, eight, nine, ten). In some instances, the number and/or arrangement of the suspension mechanisms may be selected based on the length, weight, shape or other characteristics of the body. In some embodiments, suspension mechanisms may contact the body at the end caps. For example, a lower suspension mechanism 230b may contact an end cap 220 of the lower body 210.

The suspension mechanisms may run parallel to one another. In one example, the suspension mechanisms may be collapsible within one another. For example, a first suspension mechanism may be a hollow tube, and a second suspension mechanism may be a smaller cable, cylinder or tube that may fit within the hollow tube. In one example, an upper suspension mechanism 230a may be a hollow tube, and a lower suspension mechanism 230b may be a cable or cylinder that may fit within the hollow tube, or vice versa. This may permit the lower suspension mechanism to control the height of the lower body independently of the upper suspension mechanism. For example, the lower suspension mechanism may be tethered directly to the ceiling or other overhanging support. Thus, the height of the lower body may be adjusted relative to the ceiling. Furthermore, control of the upper body may occur independently of the lower body. Adjusting the height in the upper body need not affect the position of the lower body.

In other implementations, the suspension mechanisms may run in parallel by being adjacent to one another. For example, a first suspension mechanism and a second suspension mechanism may be cables, cylinders, or tubes that are both tethered to the ceiling or overhanging support. They may be adjacent to one another. Optionally, they may both be encased in the same housing (e.g., a hollow tube) or separate housings. This may also permit the lower suspension mechanism and upper suspension mechanism to control the heights of the lower body and upper body, respectively, independently of one another.

In other implementations, the suspension mechanisms may be sequentially arranged. For example, the lower suspension mechanism may be tethered to the upper body (or end cap of the upper body). This may cause the height of the lower body to be adjusted relative to the upper body. Furthermore, adjustment of the upper suspension mechanism will affect both the upper and lower body.

As previously described, a luminaire may have any number of bodies and any number of suspension mechanisms. These suspension mechanisms may be provided in parallel, in sequence, or any combination thereof.

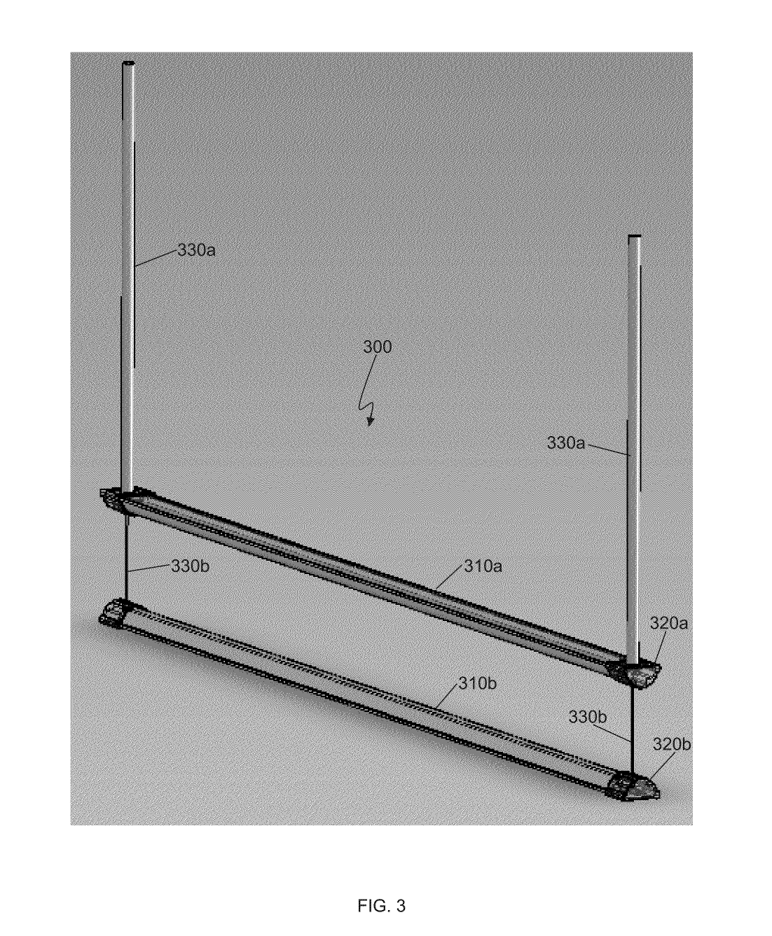

FIG. 3 shows another angle view of a linear pendant luminaire 300. The linear pendant luminaire may have multiple bodies 310a, 310b, each of which may have one or more end caps 320a, 320b. Each body may be suspended with aid of a suspension member 330a, 330b.

One or more of the suspension members may be tethered to a ceiling or other overhanging surface. The distance of each body relative to the tether may be adjustable. This may result in an overall adjustment of the height of the body and/or distance from the body to a desired target region of illumination.

In one example, an upper suspension member 330a may be tethered to a ceiling. The distance of the upper body 310a relative to the ceiling may be adjusted. This may occur by changing the length of the upper suspension mechanism. In some instances, one or more actuator, such as a motor, may aid in making this adjustment. The actuator may be on-board the luminaire, or may be provided at a tether point of the luminaire. For example, the actuator may be located within or near an end cap. Alternatively, the actuator may be located at the ceiling. In other instances, the actuator may be located anywhere along the length of the upper suspension mechanism. In some instances, multiple actuators may be provided. An actuator may respond to a command from a processor. The command signal may originate off-board the luminaire, or may originate on-board the luminaire. The command signal may be generated in response to a user input, or may be generated in response to one or more sensed conditions without requiring user input. In some instances, the command signal may be generated based on a clock measurement, light sensor, heat sensor, motion sensor, audio sensor, or other type of sensed condition.

Similarly, a lower suspension member 330b may be tethered to a ceiling. The distance of the lower body 310b relative to the ceiling may be adjusted. This may occur by changing the length of the lower suspension mechanism. In some instances, one or more actuator, such as a motor, may aid in making this adjustment. The actuator may be on-board the luminaire, or may be provided at a tether point of the luminaire. For example, the actuator may be located within or near an end cap. Alternatively, the actuator may be located at the ceiling. In other instances, the actuator may be located anywhere along the length of the lower suspension mechanism. In some instances, multiple actuators may be provided. An actuator may respond to a command from a processor. The command signal may originate off-board the luminaire, or may originate on-board the luminaire. The command signal may be generated in response to a user input, or may be generated in response to one or more sensed conditions without requiring user input. In some instances, the command signal may be generated based on a clock measurement, light sensor, heat sensor, motion sensor, audio sensor, or other type of sensed condition.

In another example, a lower suspension member 330b may be tethered to an upper body 310a (e.g., end cap of the upper body). The distance of the lower body 310b relative to the upper body may be adjusted. This may occur by changing the length of the lower suspension mechanism. In some instances, one or more actuator, such as a motor, may aid in making this adjustment. The actuator may be on-board the lower body, or may be off-board the lower body. For example, the actuator may be located within or near an end cap of the lower body. Alternatively, the actuator may be located within or near an end cap of the upper body (e.g., tether point of the lower suspension mechanism). In other instances, the actuator may be located anywhere along the length of the lower suspension mechanism. In some instances, multiple actuators may be provided.

A luminaire may be tethered to a tethering surface. Examples of tethering surfaces may include ceilings, rafters, poles, beams, walls, trees, floor, or any other surface. In some instances, a luminaire may hang beneath a tethering surface. The bodies of the luminaire may be positioned with the aid of gravity.

In some instances, the adjustments may be made manually. For example, a user may physically manipulate the suspension members and/or the bodies to have them at a desired height. In some instances, spacing adjustments may be pre-set at a factory, or at time of installation. However, these heights can be adjusted after installation, whether manually, or with aid of an actuator. This may permit the light effects of the luminaire to be dynamically adjusted. For example, it may be desirable for a lower body to be closer to a working surface under certain conditions. Depending on the configuration of the room, or other conditions, it may be desirable to adjust the height of the upper body, which may affect the overall ambient light that is provided to the room. Such adjustments may be made at any frequency (e.g., seasonally, monthly, weekly, daily, hourly, or in response to various detected conditions or commands).

Adjusting a height of the luminaire relative to a target region may affect the delivery of light to the target region. Having a lower height (i.e., luminaire closer to the target region), may increase the illuminance to the target region drastically. Adjusting a height of a luminaire relative to a ceiling may affect delivery of light to the ceiling, which may affect the overall lighting and ambience of the room. By having multiple bodies, the heights of bodies of the luminaire may be adjusted independently of one another to optimize different visual effects.

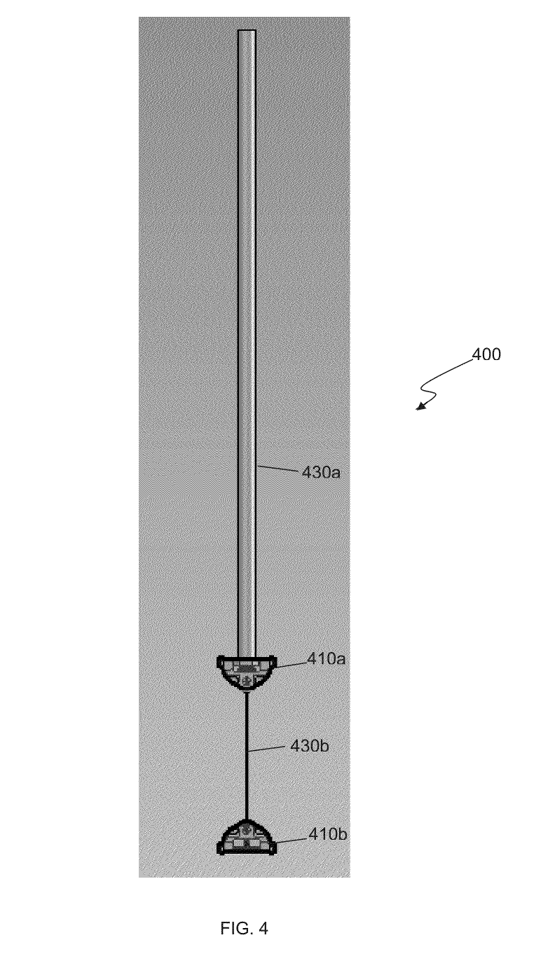

FIG. 4 shows an end view of a linear pendant luminaire 400. In some embodiments, the linear pendant luminaire may have multiple bodies 410a, 410b that may optionally be arranged at different heights. Each of the bodies may be connected to a suspension member 430a, 430b.

The multiple bodies may direct light in various primary directions. In one example, a lower body may direct light primarily downward, while an upper body may direct light primarily upwards. In some instances, the lighting of the multiple bodies may be controlled independently of one another. For example, intensity, arrangement/distribution, overall wavelengths, overall brightness, or other factors may be controlled independently between different bodies. For example, a lower body may be brightened while an upper body may remain the same. In another example, the overall wavelength output by the upper body may be adjusted to be warmer while the overall wavelength output by the lower may be adjusted to be cooler. Changes to the individual bodies may occur simultaneously in parallel, or may occur sequentially or at different times.

In one example, a lower body may primarily direct light to a working surface. The lower body may desirably be positioned close to the working surface without interfering, thereby permitting less energy to be used than when the lower body is further away, while providing the desired degree of illumination. Optionally, an upper body may primarily direct light away from the working surface to provide ambient light, so that the working region does not have the “interrogation room” or “cave”-like effect. In some embodiments, the shape of the lower body and the upper body may be similar (but provided in different directions). In other embodiments, the shapes of the lower and upper bodies may differ. In some instances, one or more optics may be provided that may cause the light distribution between the upper and lower bodies to be different. In one example, light directed to a working surface may be more focused while light distributed for ambience may be more diffuse or spread out.

One or more body may be provided to display a desired light design. For example, an upper body, or any additional body may be provided with a mask or other optics that may cause a desired design to be displayed on a surface (such as a ceiling or wall). A desired design may be projected onto a desired surface. In some examples, the desired light design may include a corporate logo or trademark. In some examples, the desired light design may include an image, letter, or shape. The desired light design may deliver a lighted message. In some instances, a lighting source may be desired to backlight a desired light design that may be viewed directly (as opposed to projected on a surface).

In some embodiments, the suspension members 430a, 430b may connect bodies 410a, 410b to one or more tether points. In one example, the luminaire may be a pendant luminaire hanging from a ceiling. The suspension members may cause the luminaire to hang in response to the effects of gravity. The suspension members may cause the positions of the bodies to be fixed or adjustable relative to the tether point.

In another example, the luminaire need not be a suspended, but may be projected from a surface. For example, the luminaire may be projected from a floor, wall, slanted surface, or any other type of surface. The support members 430a, 430b need not use suspension to position the luminaire bodies. For example, the support members may be stiff support members that can counteract the effect of gravity on the body. In one example, the support members may come out of the floor and may cause the bodies to be held up over the floor. In another example, the support members may be rigid members that protrude from a wall and hold the bodies relative to the wall (e.g., orthogonal relative to the wall, or at any angle relative to the wall). The positions of the bodies relative to the fixed surface (e.g., floor, wall, slant, ceiling) may be adjustable using any of the mechanisms described herein. The positions of the bodies relative to one another may be adjustable. The lighting control for each body may be individually controlled as described elsewhere herein. In some instances, one of the bodies may be used to light a working surface or backlight a desired light design, while another body may be used to provide ambient lighting or indirect lighting.

Support mechanisms, such as suspension mechanisms, may be used to provide electrical connections that may power the luminaire. For example, a suspension mechanism may have conductive elements that may conduct electricity from an external power source to the end caps and/or bodies of the luminaire. The light emitting elements of the luminaire may be powered, or primarily powered, from an external power source, and the suspension mechanism may have elements that may distribute the power from the external power source to the light emitting elements. For example, a power source may be built into a tethering surface, such as a ceiling, wall, floor, or other structural element. In some instances, wires, cables, cylinders, or tubes may be provided from a conductive material. In some instances, each support mechanism may power the body that it supports. Alternatively, a single support mechanism may power multiple bodies.

The support mechanism may provide both mechanical and electrical connections. The same components may be used to provide both the mechanical and electrical connections. Alternatively, different components may be used to provide primary mechanical support and primary electrical connections.

In embodiments, it may be possible to use the support mechanisms as an electrical power connection due to the type of light emitting elements that may be used by the luminaire. For instance, solid-state light sources may be used which may operate at a low voltage and/or low power.

Optionally, a local power source may be provided for a luminaire. The local power source may be in addition to, or instead of, the external power source.

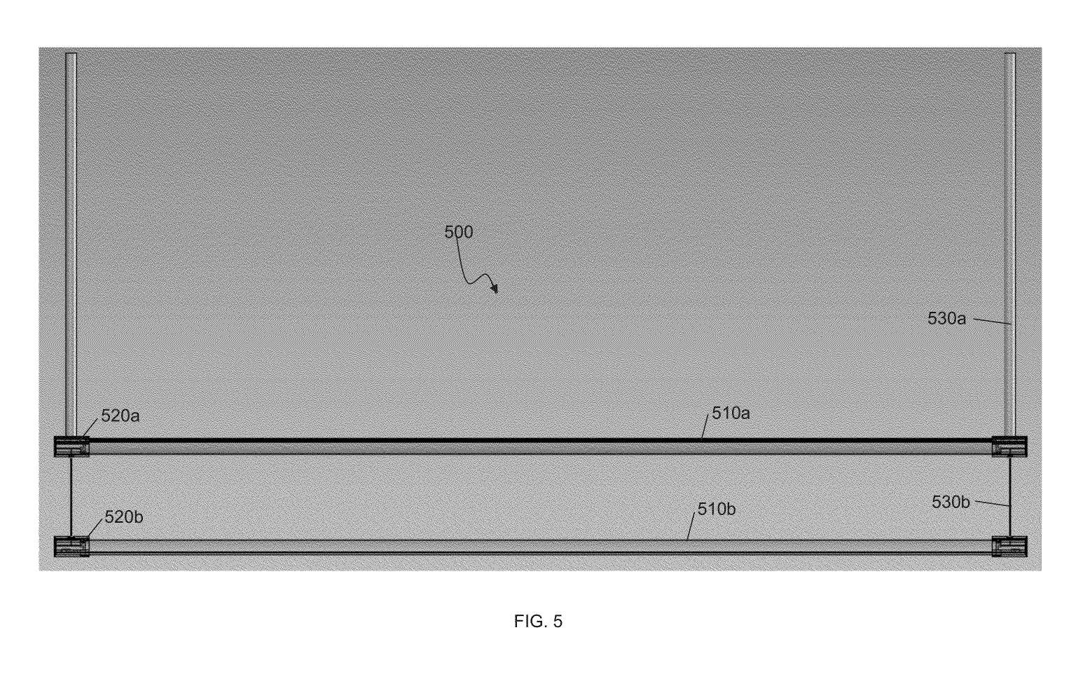

FIG. 5 shows a side view of a linear pendant luminaire 500. A plurality of elongated bodies 510a, 510b may be provided with end caps 520a, 520b and supported by hanging members 530a, 530b.

A lower body 510b may be hung beneath an upper body 510a. The bodies may be substantially parallel to one another. The position of a lower body relative to an upper body may be adjusted after installation. The position of the upper body relative to the ceiling may or may not be adjusted once installed. The position of the lower body relative to the ceiling may or may not be adjusted once installed. Adjustments may occur manually or with aid of an actuator.

Each body may emit light from one or more light emitting elements within the body. The characteristics of the light emitted by the bodies may be dynamically controlled after installation of the luminaire. Each body may be controlled independently of other bodies. For example, color of light, brightness, intensity, focus, arrangement/distribution of light may be controlled individually for each body. For example, an upper body may emit light that is controlled separately from light emitted by the lower body.

In some instances, light emitted by a body may be substantially uniform along the length of the elongated body. In other examples, light characteristics may vary along the length of the elongated body. For example, the color of the overall emitted light may be different at one end of the body from another. Alternatively, intensity of light emitted from the body may be different at the middle of the body from the ends of the body.

The length of the luminaire (and bodies of the luminaire) need not be limited to any length. Extrusion technologies may be employed to create a luminaire of desired length. Solid-state technology also permits great flexibility in length of the luminaire. In some examples, the luminaire may be greater than, less than, or equal to about 6 inches, 1 foot, 18 inches, 2 feet, 30 inches, 3 feet, 4 feet, 5 feet, 6 feet, 7 feet, or 8 feet long. The luminaire may be a length of a standard fluorescent tube. In some instances, for very long lengths, multiple units may be joined together to form any length required for an application. One or more end caps may be connected to one another, or to multiple bodies to extend the length of the luminaire.

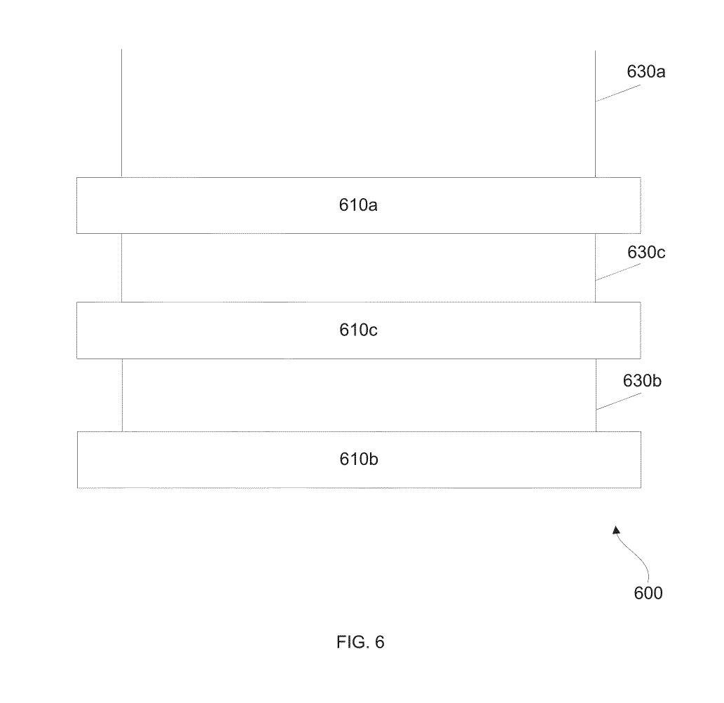

FIG. 6 shows an example of a linear pendant luminaire 600 with side lighting. Optionally, a luminaire may have multiple levels 610a 610b, 610c. In one example, an upper level 610a and lower level 610b may be provided. In some instances, an intermediary level 610c may also be provided. A single intermediary level, or multiple intermediary levels may be provided between the upper level and the lower level. The various levels may be supported by support members 630a, 630b, 630c. The support members may be tethered to a tethering surface, such as a ceiling or other type of overhang. The support members may support one or more levels using suspension.

In one example, an upper level may direct light primarily upwards, while a lower level may direct light primarily downwards. Alternatively, the upper and lower levels may direct light in any other direction. An intermediary level may direct light in a lateral direction. For example, if the luminaire is suspended within a room, the intermediary light may direct light toward the walls, or other vertical surfaces. In some embodiments, an intermediary level may have one or more light guide. An edge-lit light guide may direct light to the laterally (e.g., to the right or left).

In one example, an intermediary level may be separate level from the lower level and the upper level. Each level may have a position that is adjustable relative to another level. For example, the lower level and upper level may be movable relative to one another and/or a tether point. An intermediary level may be movable relative to the lower level and/or upper level and/or a tether point. Alternatively, the intermediary level may be fixed relative to another level. Any adjustments may be made manually or with aid of an actuator as described elsewhere herein. Adjustments may be made in response to a command or a detected condition.

An intermediary level may simultaneously provide in light in multiple lateral directions (e.g., simultaneously to the right and the left). Alternatively, an intermediary level may have a single primary direction of illumination. Multiple intermediary levels may be used to achieve lateral illumination in different directions. In some instances, the optics and/or directions of the light emitting elements may be arranged so that an individual viewing the luminaire would not experience severe glare. For instance, the light emitting elements may be directed away from the primary lateral direction of illumination. Light may be reflected and/or may pass through a diffuser or other optical element. In some instances, masking techniques may be used so the light is not shined directly into a viewer's eyes.

In alternate embodiments, the side lighting features may be incorporated into the upper level and/or lover level. For example, lateral light-guides may be built into the upper level and/or lower level to aid in the lateral distribution of light.

Each lighting level may have individualized characteristics of light. The characteristics of light of the lighting levels may be controllable and variable. The characteristics of light may be individually controllable independently of one another between levels. For instance, lighting characteristics of a top of level may be controlled independently of lighting characteristics at a lower level. One or more lighting characteristics include a spectral power distribution (SPD) of the light. The light emitting elements may be arranged in a pattern to highlight distinct SPD. The light emitting elements may individually turned on and off to create a desired SPD. The intensity of the light emitting elements may be individually controlled to create a desired SPD.

In some embodiments, the characteristics of light of the luminaire may be controlled in response to a user input. The characteristics of light may include wavelength, intensity, brightness distribution, or any other aspect of a SPD. The user may provide input via use of a remote device, such as the device described elsewhere herein. The user may provide input via a user interface that is not physically connected to the luminaire. The user may provide input via a user interface on the luminaire or physically connected to the luminaire. The characteristics of light of the levels may be individually controlled independently of one another. For instance, a user may interact with two or more separate controls to control characteristics of light from each of the corresponding two or more levels. In one example, a user may wish to provide more direct lighting to work on a project, so may increase the intensity of light from a lower level without increasing the intensity of light from an upper level. The user may later wish to provide more ambient light or mood lighting, so may decrease the intensity of light from a lower level while changing the color emitted by the upper level to a warmer color.

Characteristics of light emitted by the luminaire may be controlled in response to an output of a clock. The clock may be on-board the luminaire, or may be off-board the luminaire and may communicate with the luminaire. The clock output may be indicative of time. The characteristics of light may be altered in response to a signal indicative of time, such as time of day, day of the week, day of the month, or season. For instance, the clock may indicate that the time is 5:00 pm on January 5^{th} and it may be inferred that the sun sets earlier in the winter so the lighting intensity may be increased earlier than if the clock were to indicate the time is 7:00 pm on July 5^{th}, in which case it may still be bright outside. Lighting characteristics of each level may be individually controllable in response to an output of the clock.

Characteristics of light emitted by the luminaire may be controlled in response to a signal from one or more sensors. The sensors may be on-board the luminaire, off-board the luminaire, or both. The sensors may be photosensors, temperature sensors, motion sensors, ultrasonic sensors, inertial sensors, or any other type of sensor. For example, the sensors may detect a level of illumination in the environment and may generate a signal that is provided to the luminaire. For example, a user may wish to maintain a particular brightness within a room that has windows. As light from the outside that passes through the windows change and is detected by the sensors, the luminaire may adjust the lighting output to maintain the brightness within the room at a substantially steady level. In another example, a sensor may be motion sensor. The user may wish to keep the light off or at a low level when nobody is in the room. The motion detector may detect motion which may be indicative of a presence of a person within the room, which may cause the light to turn on or gradually brighten. Lighting characteristics of each level may be individually controllable in response to the one or more sensors.

The positions of each level of lighting may be adjustable. The positions of the levels may be adjustable relative to one another or to a common reference point. The positions of the lighting levels may be controllable and variable. A position of each level (or at least one level of said plurality) may be individually controllable. The positions may be individually controllable with aid of one or more actuators. Mechanized or automated changes in position may occur.

In some embodiments, the positions of one or more levels of the luminaire may be controlled in response to a user input. The user may provide input via use of a remote device, such as the device described elsewhere herein. The user may provide input via a user interface that is not physically connected to the luminaire. The user may provide input via a user interface on the luminaire or physically connected to the luminaire. The positions of the levels may be individually controlled independently of one another. For instance, a user may interact with two or more separate controls to control positions of each of the corresponding two or more levels. In one example, a user may wish to raise an upper level while lowering a lower level. In another example, the user may wish to lower an upper level while maintaining the position of the lower level. Input from the user may be used to generate a signal that is transmitted to one or more actuator to cause the raising and lowering of the levels. A human need not manually adjust the levels. In some instances, one or more pre-selected available options for positioning may be provided and a user may select an option from the pre-selected available options. In another instance, a user may directly control raising and lowering of the levels by providing a continuous input.

Positions of the levels may be controlled in response to an output of a clock. The clock may be on-board the luminaire, or may be off-board the luminaire and may communicate with the luminaire. The clock output may be indicative of time. The positioning of the levels may be altered in response to a signal indicative of time, such as time of day, day of the week, day of the month, or season. One or more processors may individually or collectively receive the signal from the clock and automatically generate a signal without human invention to cause adjustment of the position of one or more levels. The generated signal to cause adjustment may be sent to one or more actuators.

Positions of the levels may be controlled in response to a signal from one or more sensors. The sensors may be on-board the luminaire, off-board the luminaire, or both. The sensors may be photosensors, temperature sensors, motion sensors, ultrasonic sensors, inertial sensors, or any other type of sensor. For example, the sensors may detect a level of illumination in the environment and may generate a signal that is provided to the luminaire. One or more processors may individually or collectively receive the signal from the sensors and automatically generate a signal without human invention to cause adjustment of the position of one or more levels. The generated signal to cause adjustment may be sent to one or more actuators.

Optionally, in additional alternative embodiments, up-lighting and down-lighting may be provided within a single body. The single body may include a portion that has a primary direction of illumination upwards and a portion hat has a primary direction of illumination downwards. The lighting of these portions may be controlled independently, for instance similarly to how lighting for individual bodies may be controlled independently.

In some embodiments, side lighting features may be edge-coupled light sources. The side lighting features may be LEDs, OLEDs, or other light sources as described elsewhere herein. Any of the up and/or down lighting features may also be edge-coupled light sources, such as LEDs, OLEDs, or others. In some instances, one or more of the side lighting features may be a desired lighting design, such as a corporate logo or trademark.

Glare and or pixilation of light (i.e., in any direction whether upwards, downwards, sideways, or any angle) may be reduced using one or more techniques. For example, a mask may be employed that may block light from exiting a luminaire at the most offensive angles. In another example, reflectors, including light guides, may be used to redirect light away from a glare location. In yet another example, diffusers may be used that may spread light over a larger area and reduce luminance from the source. Diffractors, including lenses and free form optics, and refractors may also be used to redirect or diffuse light, to provide a desired distribution of light. Any of these techniques may be used alone or in combination.

In one example, light emitting elements are pointed away from a primary illumination plane and toward an efficient diffuse reflector. The diffuse reflector may redirect light onto the plane to be illuminated. This may aid in the reduction of glare and pixilation. Furthermore, the optical element may shape and control the light distribution to a desired output. Any optical elements may be used to provide a desired light distribution.

In some instances, the desired light distributions may be substantially symmetrical. Alternatively, they may be asymmetrical. One example of this may be for a wall wash.

One or more optical elements may be configured to provide a desired light distribution. For example, the shape, angle and optical properties of first and second optical elements may be configured such that the luminaire provides a “batwing” light distribution or other light distribution that is similar to that of a conventional fluorescent tube mounted in a parabolic or other conventional troffer. Alternatively, the optical elements of the luminaire may be configured such that when the luminaire includes a parabolic troffer, the light distribution profile matches that of a conventional fluorescent tube mounted in parabolic or other conventional troffer. Alternatively, the optical elements may be configured to provide a concentrated or narrow beam light distribution, or a lambertion emission profile. Optionally, a less than lambertian or a greater than lambertian emission profile may be provided. The optical elements may be used to provide wall-washing, or linear track lighting. The ability to tune the beam angle and light distribution using the optical elements is an advantageous feature of this design. Such light distribution may be provided from an overall luminaire or from each individual body of a luminaire (e.g., upper body, lower body).

An optical element may be a reflector (e.g., diffuse or specular reflector), refractors (e.g., imaging, non-imaging, or Fresnel lens), diffractors (e.g., including gratings and nano patterns), diffusers (e.g., including bulk and surface), filters (e.g., including high pass, low pass, and notch), and/or light guides (e.g., including flat and curved). An optical element may redirect, focus, diffuse, change the wavelength of, absorb, weaken, or have any other effect on light. Optionally, an optical element may be a clear window or transparent cover. A window can pass visible radiation with little attenuation but does not have optically transformative properties. Optical surfaces may or may not have anti reflective coatings to increase efficiency. Optical surfaces may or may not have luminescent materials disposed thereon.

An optical element may include portions that may be used for light reflectance, light refraction, and/or light diffraction. An optical element may have a diffuser, a lens, a mirror, optical coatings, dichroic coatings, grating, textured surface, photonic crystal, or a microlens array. The optical element may be any reflective, refractive, or diffractive component, or any combination of reflective, refractive, or diffractive components. For instance, the optical element may be both reflective and refractive.

A luminaire have one or more components, characteristics, features, or use one or more steps of lamps or luminaires as described in U.S. Pat. No. 8,491,165 issued Jul. 23, 2013, which is hereby incorporated by reference in its entirety.

Aspects of the invention may include a pendant light source having at least one control of at least one up light and at least one down light output. Said light sources can be adjustable in position from the ceiling and from each other. One or both light sources may be spectrally tunable including average light level. Said light sources may also include light sources with a horizontal primary direction of emission on at least one side. Said horizontally emitting light source may be created from edge-coupled LEDs. Said horizontally emitting light source may be an organic light emitting diode (OLED). Said horizontally emitting light source may be created from coupling light from the LED sources used to create the up and down lights. Said horizontally emitting light source may also be a corporate logo or trademark.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. A luminaire comprising:
an upper body configured to direct light primarily toward a tethering surface;
a lower body configured to direct light primarily away from the tethering surface;
at least one support member configured to support at least one of the upper body and the lower body by suspension from the tethering surface,
wherein characteristics of light distributed by the upper body and the lower body are controllable independently of one another.

2. The luminaire of claim 1 wherein the tethering surface is a ceiling.

3. The luminaire of claim 1 wherein the characteristics of light are adjusted in response to a user input.

4. The luminaire of claim 1 wherein the characteristics of light are adjusted in response to a time indicated by a clock or a signal from one or more sensors.

5. The luminaire of claim 1 wherein the characteristics of light include wavelength, intensity, or brightness.

6. The luminaire of claim 1 wherein the upper body or the lower body comprises (1) one or more light emitting elements, and (2) a modifying optic that redirects light from the one or more light emitting elements.

7. The luminaire of claim 6 wherein the light that is redirected by the modifying optic is non-pixelated.

8. The luminaire of claim 6 wherein the one or more light emitting elements are disposed on a circuit board.

9. The luminaire of claim 8 wherein the circuit board is formed of an at least partially optically transmissive material.

10. The luminaire of claim 8 wherein the circuit board comprises transparent conductors.

11. A luminaire comprising:
an upper body configured to direct light primarily toward a tethering surface;
a lower body configured to direct light primarily away from the tethering surface;
at least one support member configured to support at least one of the upper body and the lower body by suspension from the tethering surface,
wherein at least one of the upper body and the lower body is at a position that is adjustable relative to one another.

12. The luminaire of claim 11 wherein the position is adjustable with aid of an actuator.

13. The luminaire of claim 12 wherein the position is adjusted in response to a user input.

14. The luminaire of claim 12 wherein the position is adjusted in response to a time indicated by a clock or a signal from one or more sensors.

15. The luminaire of claim 12 wherein both the upper body and the lower body are at positions that are adjustable relative to the tethering surface.

16. The luminaire of claim 11 further comprising at least one infrared light emitting element for communication with a device.

17. The luminaire of claim 11 further comprising one or more luminescent materials.

18. The luminaire of claim 17 further comprising one or more ultraviolet light emitting element that excites the one or more luminescent materials.

19. A luminaire comprising:
an upper body configured to direct light primarily toward a tethering surface, wherein the upper body comprises one or more light emitting elements that emit light in a direction that is different from toward the tethering surface;
a lower body configured to direct light primarily away from the tethering surface, wherein the lower body comprises one or more light emitting elements that emit light in a direction that is different from away from the tethering surface;
at least one support member configured to support at least one of the upper body and the lower body by suspension from the tethering surface.

20. The luminaire of claim 19 further comprising one or more modifying optical elements that individually or collectively redirect light emitted by the one or more light emitting elements of the upper body or the lower body.
